(19) United States
(12) Patent Application Publication
(10) Pub. No.: US 2013/0116999 A1
(43) Pub. Date: May 9, 2013

(54) Patient-Specific Modeling and Forecasting of Disease Progression

(71) Applicant: The Regents Of The University Of Michigan, Ann Arbor, MI (US)

(72) Inventors: Joshua Stein, Ann Arbor, MI (US); Mariel Lavieri, Ann Arbor, MI (US); Mark Van Oyen, Ann Arbor, MI (US); Jonathan Helm, Ann Arbor, MI (US); David Musch, Ypsilanti, MI (US); Gregg Shell, Ann Arbor, MI (US)

(73) Assignee: THE REGENTS OF THE UNIVERSITY OF MICHIGAN, Ann Arbor, MI (US)

(21) Appl. No.: 13/668,280

(22) Filed: Nov. 4, 2012

Related U.S. Application Data
(60) Provisional application No. 61/555,974, filed on Nov. 4, 2011.

(51) Int. Cl. G06G 7/60

(52) U.S. Cl. 703/11

(57) ABSTRACT

A computer-implemented method models and forecasts progression of a disease for a patient. The method includes, customizing a multivariate state space model for the patient based on test history data for the patient, the multivariate state space model comprising a model state representative of the disease progression for the patient, generating, using the customized multivariate state space model, a forecast of the model state based on a current representation of the model state and current measurement data for a test that observes measurements relevant to the progression of the disease, and converting the model state forecast into a disease progression probability.

### RELATED APPLICATIONS

The present patent application claims the benefit of the filing date under 35 U.S.C. §119(e) of U.S. Provisional Patent Application Ser. No. 61/555,974, filed Nov. 4, 2011, which is hereby incorporated by reference herein in its entirety.

### BACKGROUND OF THE DISCLOSURE

1. Field of the Disclosure

The disclosure generally relates to disease progression monitoring.

2. Brief Description of Related Technology

Glaucoma is a chronic condition that causes visual impairment in the United States and worldwide. It is estimated that over 2.2 million Americans have glaucoma, and the number is expected to grow to more than 3 million by 2020. Glaucoma is often asymptomatic early in the course of the disease; but if left untreated, it leads to gradual and progressive loss of vision and may, ultimately, result in irreversible blindness. Early identification of the progression of and appropriate treatment for glaucoma can, however, slow or halt the rate of vision loss.

Patients suffering from glaucoma are monitored periodically via quantitative tests to determine whether the disease is stable or a change in treatment is warranted to slow glaucoma-related vision loss. There is often a tradeoff between monitoring intervals that are too short (little information is gained between readings, and there is unnecessary cost and undue discomfort and/or anxiety for the patients), and too long (the patient's long term outcomes may be affected adversely by the delay in detecting disease progression). However, because the disease progresses differently for different patients, the ideal frequency of testing can vary from patient to patient, and no consensus exists as to the optimal frequency by which testing should take place.

The standard for glaucoma care is to periodically measure intraocular pressure (IOP) and peripheral vision, as captured by visual field (VF) testing, to determine if and when an intervention should be performed to slow glaucoma-related vision loss. The IOP test measures the fluid pressure in the eye. The automated VF test examines the sensitivity of the eye to light stimuli, which is a way of quantifying peripheral vision loss. Testing noise is associated with both IOP readings and VF test results. During the VF test patients can get nervous or tired, which can lead to false positive and false negative responses. Moreover, patients may experience fixation losses which can introduce error into test results. The VF test can be long and burdensome, particularly for elderly patients. Subject to the judgment and expertise of eye care providers, the frequency with which patients undergo testing may be as frequent as every few months or as infrequent as every two years. This frequency depends on a variety of factors, including disease severity and stability of the disease. The expense of conducting these tests can be significant for both the patients and the overall healthcare system.

### BRIEF SUMMARY OF THE DISCLOSURE

In accordance with one aspect of the disclosure, a computer-implemented method may be provided for modeling and forecasting progression of a disease for a patient. The method includes customizing a multivariate state space model for the patient based on test history data for the patient, the multivariate state space model including a model state representative of the disease progression for the patient; generating, using the customized multivariate state space model, a forecast of the model state based on a current representation of the model state and current measurement data for a test directed to observing progression of the disease; and converting the model state forecast into a disease progression probability.

The multivariate state space model may include a linear Gaussian system. The model state may then specify a current configuration of the linear Gaussian system. The linear Gaussian system may include a Kalman filter. Alternatively or additionally, the current representation of the model state and the model state forecast may be specified via respective Gaussian distributions.

Generating the model state forecast may include updating the customized multivariate state space model based on further measurement data for the test. Alternatively or additionally, generating the model state forecast may further include: predicting a future model state based on a linear state transition matrix of the customized multivariate state space model and a representation of biological process noise arising during the progression of the disease; and updating the multivariate state space model by minimizing a function of the co-variance of the estimate with the mean error being unbiased between the predicted future model state and new test data for the patient, the new test data including a representation of test measurement noise.

Predicting the estimate of the future model state may be recursively implemented, and updating the multivariate state space model may not be implemented during each implementation of the forecast generating act in which the new test data is not available. Converting the model state forecast may include mapping the model state forecast to the disease progression probability via a logistic regression function.

The method may further include determining a future test timing based on the disease progression probability and a progression threshold. Determining the future test timing may then include estimating a maximum possible disease progression probability by maximizing the logistic regression function over a Gaussian distribution of the model state forecast in accordance with a confidence level that can be adjusted by the clinician to accommodate patient-specific needs. The progression threshold may be adjustable, via user input, based on individual needs of the patient.

The computer-implemented method may include receiving the current measurement data at non-fixed intervals.

The disease may be glaucoma. The model state may include representations of second and third derivatives with respect to time of visual field data, intraocular pressure data, or a combination of the visual field data and the intraocular pressure data, for the patient.

The method may further include calibrating the multivariate state space model based on training data indicative of the progression of the disease for a patient population state.

In accordance with another aspect of the disclosure, a system may be provided for determining future timing of a test for a patient, the test being directed to observing progression of a disease. The system includes a memory and a processor in communication with the memory. The system further includes, a first module stored on the memory and executable by the processor to cause the processor to customize a multivariate state space model for the patient based on test history data for the patient, the multivariate state space model including a model state representative of the disease progression for the patient, a second module stored on the memory and executable by the processor to cause the processor to generate, using the customized multivariate state space model, a forecast of the model state based on a current representation of the model state and current measurement data for the test, a third module stored on the memory and executable by the processor to cause the processor to convert the model state forecast into a disease progression probability, and a fourth module stored on the memory and executable by the processor to cause the processor to determine the future test timing based on the disease progression probability and a progression threshold.

The multivariate state space model may include a linear Gaussian system that has a Kalman filter. The model state may in turn specify a current configuration of the linear Gaussian system. Alternatively or additionally, the model state may be specified via a Gaussian distribution.

The second module may be executable by the processor to cause the processor to update the multivariate state space model by minimizing error between the forecast of the model state and test measurement data for the patient. The test measurement data may be received at non-fixed intervals.

The disease may be glaucoma. The model state may include representations of second and third derivatives with respect to time of visual field data and intraocular pressure data for the patient.

The predetermined progression threshold may be determined based on a multi-zone aggressiveness scale.

In accordance with yet another aspect of the disclosure, a computer program product stored on a tangible computer-readable medium includes computer-readable instructions executable by a processor to monitor progression of a disease for a patient. The computer-readable instructions include a first instruction set configured to calibrate a multivariate state space model of the disease progression with training data of the progression of the disease for a patient population set, the multivariate state space model including a linear Gaussian system and a model state representative of the disease progression, the model state specifying a current configuration of the linear Gaussian system, a second instruction set configured to customize the multivariate state space model for the patient based on test history data for the patient, a third instruction set configured to generate, using the customized multivariate state space model, a prediction of a future model state based on the model state and a representation of biological process noise arising during the progression of the disease, and a fourth instruction set configured to update the multivariate state space model by minimizing error between the prediction of the future model state and test measurement data for the patient. The fourth instruction set is further configured to incorporate a representation of test measurement noise into the test measurement data.

The third instruction set may be configured to recursively generate the prediction of the future model state. The fourth instruction set may be configured not to update the multivariate state space model during a recursive generation period in which the test measurement data is not available. The fourth instruction set may be configured to update the multivariate state space model by minimizing a function of a co-variance of the prediction of the future model state with a mean error being unbiased between the prediction of the future model state and the test measurement data for the patient.

### BRIEF DESCRIPTION OF THE DRAWING FIGURES

The components and the figures are not necessarily to scale, emphasis instead being placed upon illustrating the principles of the invention. Moreover, in the figures, like reference numerals designate corresponding parts throughout the different views.

FIG. 1 is a block diagram of an exemplary disease monitoring and modeling system.

FIG. 2 depicts an exemplary model used in the disease and modeling system of FIG. 1.

FIG. 3 is a flow diagram depicting a method of providing disease monitoring and modeling according to one embodiment.

FIG. 4 is a flow diagram depicting stages of the method of FIG. 3 according to one embodiment.

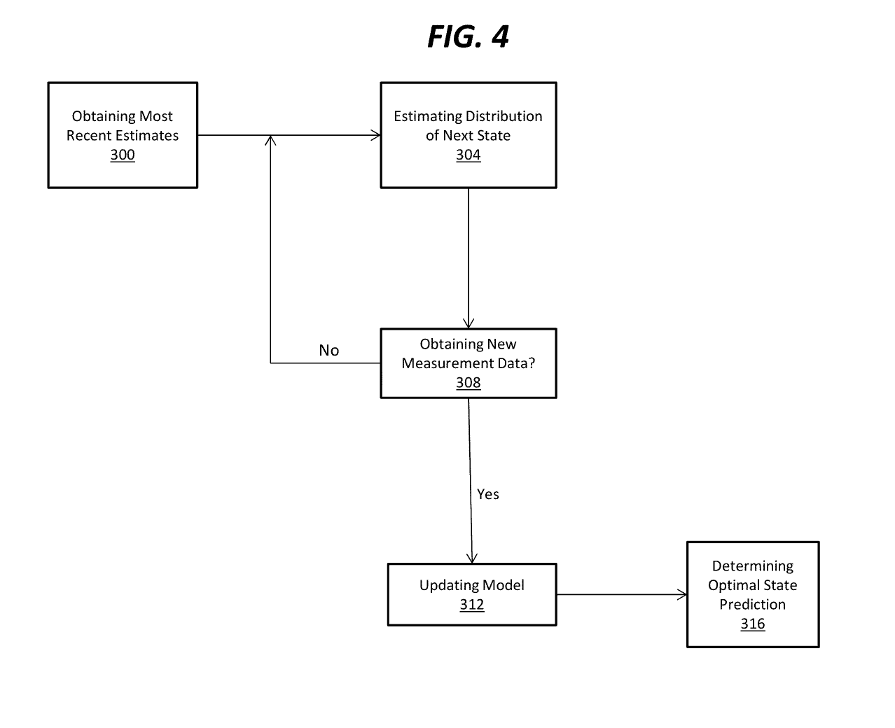

FIG. 5 is a graphical plot of sample output data from stages of the method of FIG. 3 according to one embodiment.

FIG. 6 are graphical plots of prediction error as a function of the number of periods predicted in connection with certain stages of the method of FIG. 3 according to one embodiment.

FIG. 7 is a graphical plot that depicts how the time to next test is determined as part of the method of FIG. 3 according to one embodiment.

FIG. 8 presents a pair of graphical plots that depict time to next test determinations as part of the method of FIG. 3 according to one embodiment.

### DETAILED DESCRIPTION OF THE PREFERRED EMBODIMENTS

The disclosed embodiments relate to disease progression modeling and forecasting. The disclosed embodiments may customize a disease progression model based on patient-specific data. Rather than attempt to try and fit or match the patient data to a known disease profile, the disclosed embodiments may be configured to deviate from population-based data as data for a particular patient is incorporated into the model over time. The disclosed embodiments may create a model of the system dynamics of clinical measurements associated with the disease based on a set of sequential measurements (e.g., with time stamps for the clinical measurements). The measurements need not be taken regularly or uniformly (e.g., at fixed intervals). For example, an entire set of clinical measurements need not be obtained at the same time points. The disclosed embodiments may forecast future values of clinical measurements at any point in time at or later than the latest test measurement. The forecasting may be based on a model of the system dynamics of the clinical measurements associated with the disease. The disclosed embodiments may determine an effective time-to-next-test (TNT) based on (1) the forecasting model for the future values of the clinical measurements associated with the disease, and (2) a model or function representative of the probability of disease progression as a function of any number of clinical measurements over time.

There is a tradeoff between monitoring intervals that are either too short (high cost) and too long (disease progression goes undetected). The disclosed embodiments may provide population-based or trained dynamic algorithms or models of disease progression. The models may accommodate large state spaces and rich data inputs. The models may be continuous state models, such as models that include dynamic linear Gaussian systems models and a Kalman Filter, of disease progression. The models may use, integrate, or consider patient-specific disease dynamics and the variability around those dynamics, captured from studying individual patient output (e.g., test results) from prior tests, with the population information. Information or data from each successive test is considered to gather additional knowledge about the patient's disease dynamics and further tailor the policy to the specific patient. Accordingly, the disclosed models may be driven by rich patient information that accumulates as more tests are administered. The dynamics may be specified by first order vector difference equations. By including in the state not only a test measurement itself, but one or more derivatives (e.g., second, third, and fourth in one example of the disclosed models) and noise dynamics, a model of disease progression that captures a wide range of dynamic behavior may be provided. The models may also be configured to capture correlated multivariate white noise that is present in many medical tests, including, for example, VF tests and IOP tests.

Using these dynamics, the models may, predict future progression of the disease (e.g., performance of the visual field in glaucoma patients) and identify the optimal or most appropriate time to re-test the patient (e.g., when to re-check the patient's visual field) to best identify patients who are at risk of serious complications due to the disease progression. The determined best time to next test may be based on the learned knowledge of the patient's specific disease trajectory. Since diseases, particularly glaucoma, progress along different trajectories for different patients, the disclosed models may dynamically use data from an individual patient to predict his or her trajectory and future damage.

In contrast with traditional approaches, the disclosed embodiments may provide a dynamic policy adaptable to specific patient needs. Traditional approaches, such as Markov Decision Process based approaches, are often based on solving an optimization model off-line and using the output or structural insights to guide population-wide testing decisions in a static manner. Traditional approaches typically do not incorporate or consider patient outcomes and utilize little, if any, clinical patient data. Although the disclosed embodiments may obtain and consider structural insights, the disclosed embodiments may include a feedback control-based approach that dynamically updates the model or algorithm as additional patient data are obtained. Furthermore, the disclosed embodiments may forecast the patient disease state into the future until there is no longer statistical confidence that the forecasted disease state has not passed a progression threshold, at which point another test is recommended. The disclosed models may allow the clinician to control or adjust both the confidence level and the progression threshold to tailor the treatment and monitoring intervals to specific patient needs and/or characteristics (e.g. age, financial resources, risk tolerance, etc.). This may create a flexible, patient-oriented, and clinically relevant contrast to traditional optimization approaches that produce a “one size fits all” policy, e.g., a policy that treats two patients with the same symptoms in the same way. Two patients can experience the exact same symptoms very differently and, therefore, treatments should be tailored to the patient's experience of the symptoms and not just to the symptoms themselves. For example, a clinician may prescribe a different treatment approach for a sick elderly patient versus a young healthy patient if they had the same level of glaucoma.

For these and other reasons, the disclosed embodiments may achieve greater accuracy (with regard to identifying disease progression) with fewer examinations. The disclosed embodiments may thus lead to more efficient and effective use of available health-care resources.

In contrast with traditional approaches, which have very little generalizability to different chronic diseases, the disclosed embodiments may be applied in connection with a variety of chronic diseases and may contribute in a variety of contexts to more efficient use of healthcare resources and more effective patient care. For example, the disclosed embodiments may be applied in connection with glaucoma. The monitoring challenges addressed by the disclosed embodiments are, however, not unique to glaucoma. The disclosed methodology may assist clinicians caring for patients with an array of medical conditions. Other diseases that may benefit from the disclosed methods include those that are: (1) asymptomatic early on in the disease, (2) effectively treatable to prevent morbidity and mortality if progression is detected early enough, (3) progressive and require patients to be followed over extended periods of time, (4) can lead to serious complications (blindness, kidney failure, stroke, heart attack, etc.), (5) have quantifiable measures (protein level measurements, blood pressure measurements, viral load levels, etc.), or combinations thereof. Examples of chronic diseases for which physicians periodically monitor a number of quantifiable medical tests to capture progression include other ophthalmic diseases, non-ophthalmic diseases (e.g., diabetes mellitus, connective tissue diseases, and kidney diseases), and other diseases or conditions.

Although described below in connection with determining the future timing of a test for a patient, the disclosed embodiments may be used to determine or assess whether additional tests are needed (for example, the uncertainty of the model may be too large, such that additional tests are needed to reduce it to an acceptable level), determine whether or not medical intervention in some form (to be determined, for example, by a clinician) is necessary and/or appropriate, the need for a particular test, the need for a particular medical intervention, the proper or appropriate test (from a plurality of tests) and/or medical intervention (from a plurality of potential medical interventions), for other medical purposes, or combinations thereof.

Although described below in connection with patient management by a clinician, the disclosed embodiments may be used by the patient (to, for example, make medical decisions), other people, insurers, employers, third-party payers, other entities, or combinations thereof. Moreover, although the disclosed embodiments are described below in connection with disease progression and assessing a response to treatment, the disclosed embodiments may also be used to assess or determine the effectiveness of the treatment as compared to other treatments, assess or determine whether the patient is progressing despite treatment, for other reasons, or combinations thereof.

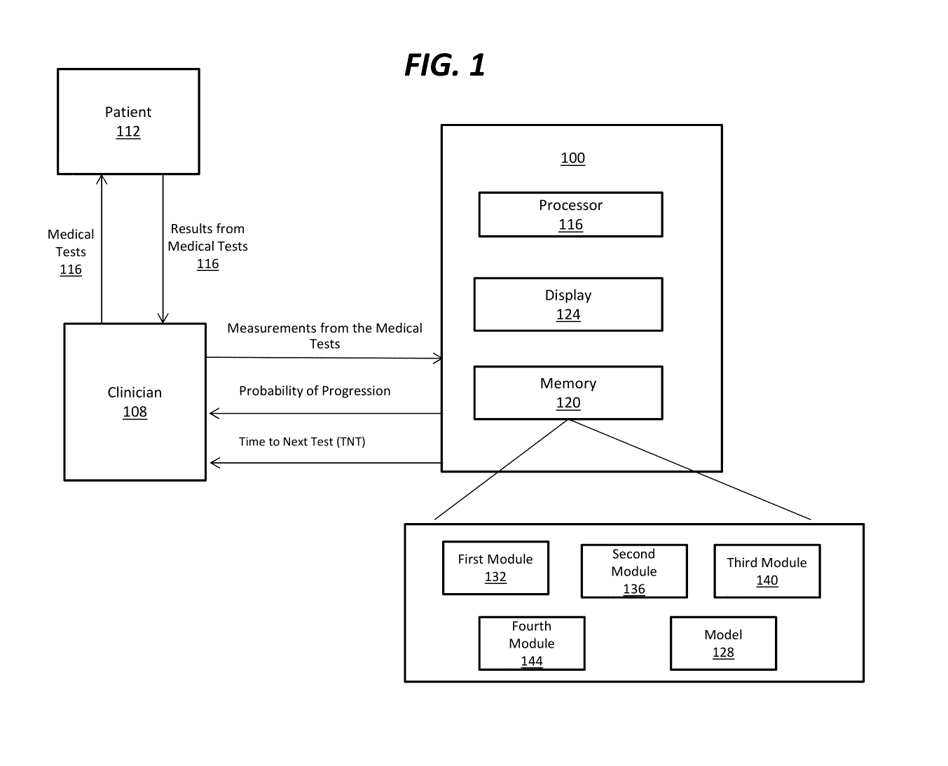

FIG. 1 illustrates a system 100 for modeling and forecasting disease progression. As shown in FIG. 1, the system 100 includes a processor 116 and a number of components coupled thereto, including a memory 120, a display 124, and a model or module 128 stored in or on the memory 120. In other embodiments, the system 100 may include additional, different, or fewer components. In other embodiments, the system 100 may include additional, fewer, or different components. For example, the system 100 may include a plurality of different and/or similar models 128. In one embodiment, the system 100, and the components thereof, may be implemented as computer program logic or computer readable program code stored in the memory and/or storage of a computer, and may be executable by one or more processors thereof to implement the disclosed functionality.

The processor 116 may be a central processing unit (CPU), a graphics processing unit (GPU), or both. The processor 116 may be a component in a variety of systems. For example, the processor 116 may be part of a standard personal computer or a workstation or a piece of diagnostic equipment used in a clinical setting. The processor 116 may be one or more general processors, digital signal processors, application specific integrated circuits, field programmable gate arrays, servers, networks, digital circuits, analog circuits, combinations thereof, or other now known or later developed devices for analyzing and processing data.

The memory 120 may communicate via a bus. The memory 120 may be a main memory, a static memory, or a dynamic memory. The memory 120 may include, but not limited to, computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 120 may include a cache or random access memory for the processor 116. Alternatively or additionally, the memory 120 may be separate from the processor 116, such as a cache memory of a processor, the system memory, or other memory. The memory 120 may be an external storage device or database for storing data. Examples may include a hard drive, compact disc (“CD”), digital video disc (“DVD”), memory card, memory stick, floppy disc, universal serial bus (“USB”) memory device, or any other device operative to store data.

The memory 120 may be operable to store instructions executable by the processor. The functions, acts or tasks illustrated in the figures or described herein may be performed by the programmed processor executing the instructions stored in the memory. In some embodiments, the system 100 includes one or more modules stored on the memory (e.g., the computer-readable medium) and executable by the processor to cause the processor to perform one or more functions, acts, or tasks. The system 100 may include a plurality of different modules stored on the memory and executable by the processor to cause the processor to perform a plurality of different functions, acts, or tasks, respectively. The functions, acts or tasks may be independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The display 124 may be a liquid crystal display (LCD), light-emitting diode (LED) screen, an organic light emitting diode (OLED) display, a flat panel display, a solid state display, a cathode ray tube (CRT), a thin film transistor screen, a projector, a printer or other now known or later developed display device for outputting determined information. The display may act as an interface for the user to see the functioning of the processor 116, or specifically as an interface with the software stored in the memory 120 or in the drive unit.

In other embodiments, the system 100 may include an input device configured to allow a user to interact with any of the components of the system. The input device may be a number pad, a keyboard, or a cursor control device, such as a mouse, or a joystick, touch screen display, remote control or any other device operative to interact with the system.

Additionally or alternatively, the system 100 may also include a disk or optical drive unit. The disk drive unit may include a computer-readable medium in which one or more sets of instructions, e.g. software, can be embedded. Further, the instructions may perform one or more of the methods or logic as described herein. The instructions may reside completely, or at least partially, within the memory and/or within the processor during execution by the computer system. The memory and the processor also may include computer-readable media as discussed above and/or below.

As shown in FIG. 1, the system 100 includes four different modules 132, 136, 140, and 144 stored on or in the memory 120. The modules 132, 136, 140, and 144, are executable by the processor 116 to cause the processor 116 to perform a different function, act, or task described herein (e.g., customizing, generating, determining, etc), as will be described in greater detail below. In other embodiments, one or more of the modules 132, 136, 140, 144 may perform more than one function, act, or task described herein. In yet other embodiments, the system 100 may include additional, fewer, or different modules stored on the memory 120 or on another memory and executable by the processor 116 or another processor to cause the processor 116 (or another processor) to perform one or more functions, acts, or tasks.

The system 100 may be used by a clinician 108, such as a physician, nurse, or other health professional, in connection with treating or caring for a patient 112 with a chronic condition or disease (e.g., glaucoma). The system 100 may be used by any number of different clinicians 108 in connection with treating or caring for any number of patients 112 having the same or different conditions or diseases.

The model or module 128 may provide patient-specific modeling and disease progression forecasting for or otherwise in connection with the patient 112. The model 128 monitors disease progression for a patient 112 with a chronic condition or disease. The model 128 may be used by a clinician 108, such as a physician, nurse, or other health professional in connection with treating or caring for the patient 112 with a chronic condition or disease (e.g., glaucoma). The model 128 may be used by any number of different clinicians 108 in connection with treating or caring for any number of patients 112 having the same or different conditions or diseases. Alternatively or additionally, the model 128 may be used by the patient 112 (or another patient), by insurers, by employers, by third-party payers, another party or entity, or combinations thereof, in connection with making medical decisions, insurance decisions, and/or other decisions.

The patient 112 has a chronic condition or disease. The chronic condition or disease may be characterized as being (1) asymptomatic early, (2) effectively treatable to prevent morbidity and mortality if progression of the disease or condition is detected early enough, (3) progressive and requiring patients to be followed over extended periods of time, (4) capable of causing serious complications (e.g., blindness, kidney failure, stroke, heart attack, etc.), (5) having quantifiable measurements (e.g., protein level measurements, blood pressure measurements, viral load levels, etc.) measured or collected by quantifiable medical tests, or various combinations thereof. In some embodiments, the chronic condition or disease is an ophthalmic disease (e.g., glaucoma). In other embodiments, the chronic condition or disease may be a non-ophthalmic disease, such as diabetes mellitus, kidney disease, connective tissue disease, Alzheimer's disease, Parkinson's Disease, and Amyotrophic lateral sclerosis (ALS), or the like, or may be another chronic disease or condition.

The patient 112 is given or administered quantifiable medical tests 160 by, for example, the clinician 108 or another health professional. The quantifiable medical tests 160 may be given or administered at fixed or non-fixed intervals. The medical tests 160 are designed to gather or extract information about the state of the patient's disease or condition. In the embodiments in which the patient's chronic condition or disease is glaucoma, the medical tests 160 include VF and IOP tests that seek to gather information or measurements about or indicative of the state of the patient's glaucoma. In other embodiments, the medical tests 160 may include additional or different existing or later developed tests. The tests 160 may be perturbed by noise, such as process or system noise (e.g., stochastic disease evolution) and/or measurement noise (e.g., testing errors).

The measurements from the medical tests 160 may be fed or entered into the model 128 for the chronic disease. The measurements may be automatically fed or entered into the model and/or manually fed or entered into the model 128. In one embodiment, the model may capture or obtain the measurements (stored, for example, on a website, computer, etc.) When the model 128, which may be customized based on test or measurement history data for the patient 112 via, for example, the first module 132 executable by the processor 116, receives or obtains the quantifiable measurements from the medical tests 160 (at fixed and/or non-fixed intervals), the model 128 may be configured to estimate the current disease state for the patient 112 and forecast or predict, via, for example, the second module 136 executable by the processor 116, future disease states for the patient 112. In some embodiments, the model 128 may be updated, via, for example, the second module 136 executable by the processor 116, by minimizing error between the forecast of the model state and the received test measurement data for the patient. Using the forecasted disease state, the model 128 may, in turn, convert, via, for example, the third module 140 executable by the processor 116, the disease state into a probability that the patient 112 will have progressed sufficiently to warrant a change in disease management and/or treatment. The model 128 may then identify or determine, via, for example, the fourth module 144 executable by the processor 116, the time until next test (TNT) or the earliest point in time at which the patient's forecasted probability of progression exceeds or will exceed a progression threshold. The progression threshold may be predetermined and/or adjusted based on the treatment strategy for the patient 112. In some embodiments, the progression threshold may be chosen or set based on an aggressiveness scale. The model 128 may transmit or send the probability of progression and the identified TNT to the clinician 108 for use in managing and/or treating the patient 112.

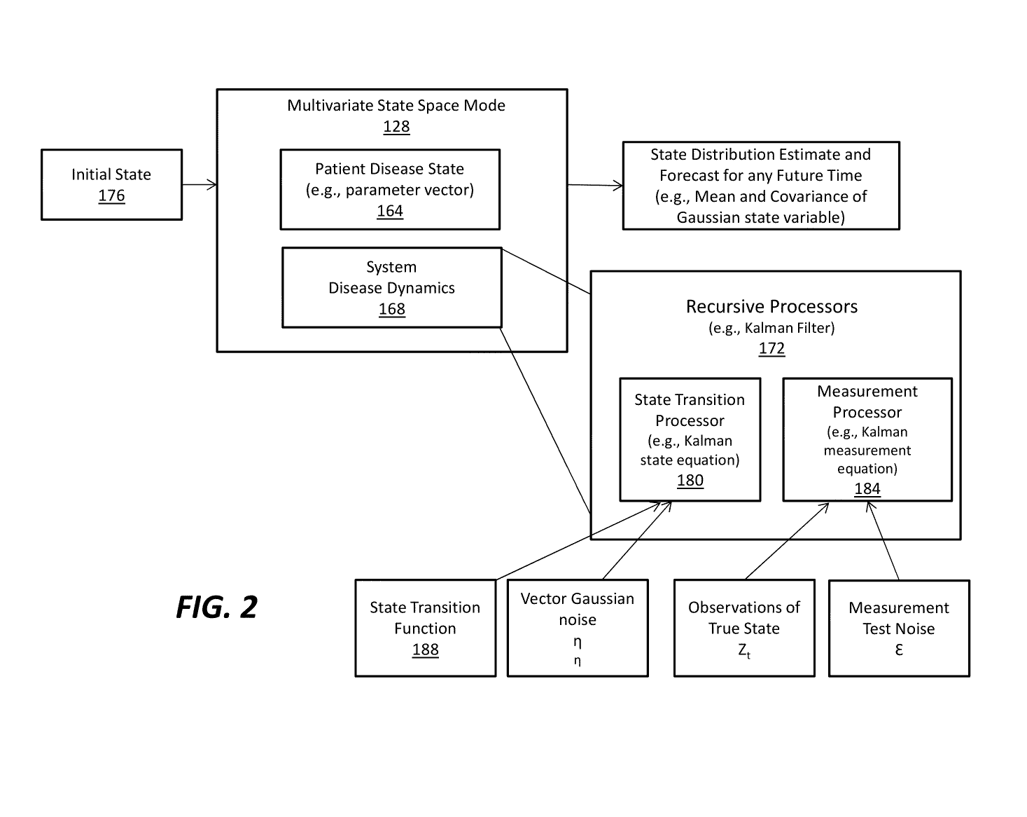

FIG. 2 depicts the model 128 in accordance with one embodiment. The model 128 is a multivariate state space model. The model may be a time-variant model or a time-invariant model. The model 128 may include a linear Gaussian system and/or additional or different systems. For example, the model 128 may include a non-linear and/or non-Gaussian system. The linear Gaussian system need not have fixed observation intervals. The linear Gaussian system may, in some embodiments, include a Kalman filter. When the model 128 includes a linear Gaussian system, the model 128 may account for or incorporate process noise, which may be representative of the effect of un-modeled disease dynamics, and/or measurement noise from medical test measurements. For example, the model 128 may approximate one or more of such effects.

As shown in FIG. 2, the model 128 according to one embodiment includes a model or patient disease state 164, system disease dynamics 168, and recursive processors 172, and has an initial state 176. In other embodiments, the model 128 may include additional, fewer, or different components. For example, the model 128 may include different recursive processors 172 than the ones described in connection with the preferred embodiments.

The model state 164 is representative of the progression of the disease. The model state 164 specifies a current configuration of the model 128, such as, for example, a current configuration of the linear Gaussian system. The model state 164 may be represented or specified by or via a Gaussian distribution. In other embodiments, the model state 164 may be represented by or via a non-Gaussian distribution. The model state 164 may include any parameters or data represented by the parameters (e.g., key patient data or parameters) relevant to indicating the severity and/or the progression of the disease. The model 128 is flexible in the sense that any number of parameters and/or any type of data represented by the parameters may be used. For example, the model state 164 may include data derived from or obtained via VF tests, such as pattern standard deviation (PSD) data, mean deviation data, etc., (current evidence indicates that the primary indicator of glaucoma progression is worsening of the visual field), data derived from or obtained via IOP tests (current evidence indicates that IOP is a risk factor for future glaucoma progression), patient characteristic data, such as race, age, gender, etc.), socio-demographic characteristic data, any medical comorbidities (e.g., ocular comorbidities), other data obtained in or from one or more medical tests 116 (e.g., a VF test) or quantifiable measurements, data obtained from structural testing of the chronic disease or condition (e.g., glaucoma), data from optical coherence tomography measurements, scanning laser polarimetry measurements, and/or confocal scanning laser ophthalmoscopy measurements, or combinations thereof.

The model state 164 may include representations of derivatives (e.g., first, second, third, and higher derivatives, or combinations thereof) with respect to time of the parameters or data represented by the parameters. In some embodiments, the model state 164 includes representations of derivatives with respect to time of VF data (e.g., PSD data, mean deviation data), IOP data, or a combination of the VF data and the IOP data, for the patient 112. The model state 164 may include representations of first, second, and third derivatives with respect to time of VF data, IOP data, or a combination of the VF data and the IOP data, for the patient 112. For example, the model state 164, represented by αₜ, may be as follows:

$$\text{?} = [ VF \cdot \frac{\text{?}}{\text{?}} , \frac{\text{?}}{\text{?}} , \frac{\text{?}}{\text{?}} , IOP , \frac{\text{?}}{\text{?}} , \frac{\text{?}}{\text{?}} , \frac{\text{?}}{\text{?}} ] , \\ \text{?} \text{indicates text missing or illegible when filed} \qquad ( 1 )$$

where VF refers to a global measure of performance from the VF test. As shown in equation (1), the model state 164 includes three derivatives of VF, which refer to the first three moments of the VF measure with respect to time: velocity, acceleration, and jerk. IOP represents the intraocular pressure measurement. The model state 164 includes three derivatives of IOP, which refer to the first three moments of the IOP measure with respect to time: velocity, acceleration, and jerk. The third moment, jerk, may be included to address sudden fluctuations in IOP and VF performance. In other embodiments, the model state 164 may include representations of derivatives with respect to time of, patient characteristic data (e.g., race, age, etc.), socio-demographic characteristic data, data from optical coherence tomography measurements, scanning laser polarimetry measurements, and/or confocal scanning laser ophthalmoscopy measurements, other data, or combinations thereof.

The system disease dynamics 168 are formulated or defined for the model. In these embodiments, the system disease dynamics 168 are linear system disease dynamics. In other embodiments, the system disease dynamics 168 may be non-linear system disease dynamics. The linear system disease dynamics 168 may include the recursive processors 172, such that the model 128 is a recursive model. The recursive processors 172 in these embodiments include a state transition processor 180 and a measurement processor 184. In other embodiments, the recursive processors 172 may include additional, fewer, or different processors. The state transition processor 180 processes a state transition equation or function 188, which defines how the disease is progressing from one period to the next. In these embodiments, the state transition equation or function 188 is a linear state transition equation or function. In other embodiments, the state transition equation or function 188 may be a non-linear state transition equation or function. The measurement processor 184 processes a measurement equation, which indicates the system's observation of the disease state through medical testing.

In each period, t, the system transitions to a new state according to a linear state transition matrix T and a vector Gaussian white noise input η. The Gaussian noise represents un-modeled disease process noise. The recursive transition equation is given by

αₜ=Tαₜ₋₁+η t=1, . . . N, (2)

where η is a Gaussian random vector with E[η]=0 and Var[η]=Q. The system state, αₜ, is also a Gaussian random variable for all t since it is the result of a linear combination of Gaussian random variables. Non-white noise is present in some applications, which could be accounted for by generalizing the observation model (see Eq. 3) or by using state augmentation to model colored noise by passing the white noise through a linear system model.

In the measurement equation, zₜ represents the observation vector, e.g., the outcomes of the series of tests that are performed or administered at each patient's visit (e.g., at each glaucoma patient's visit), Z is the matrix that determines how components of the true state, αₜ, are observed, and ε is the Gaussian noise component that represents the test noise described above. The measurement equation has the form

zₜ=Z [symbol] + [symbol] t=1, . . . , N, (3)

where ε is a Gaussian random variable with E[ε]=0 and Var[ε]=H. The observation zt is a Gaussian random variable for all t.

The initial state 176 of the model 128 may be assumed before any data is received. For example, the initial state 176 may be a Gaussian random vector, X₀, with E[X₀]=\hat{α}₀ and covariance matrix Var[X₀]=\hat{Σ}₀. In the embodiments in which the model 128 includes a linear Gaussian system and the linear Gaussian system includes a Kalman filter, the goal, as described herein, is to estimate the mean and covariance parameters of the Gaussian state variable.

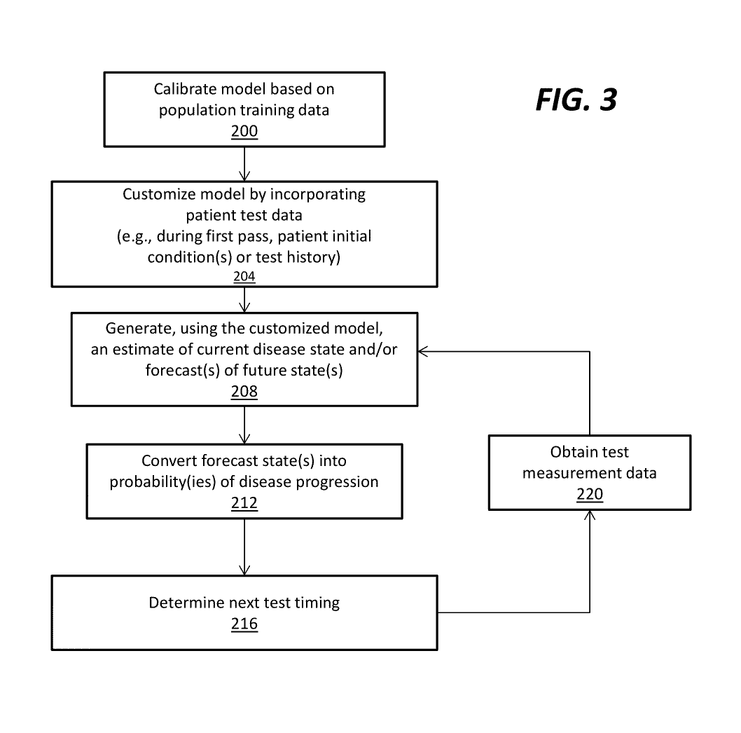

FIG. 3 illustrates a flow chart depicting a method for modeling and forecasting disease progression for the patient 112 according to one embodiment. The method may be implemented during operation of the system 100 of FIG. 1. Any of the acts described herein may, for example, be performed when a processor (e.g., the processor 116) executes one or more modules (e.g., modules 132, 136, 140, 144) stored on a memory (e.g., the memory 120).

As shown in FIG. 3, in this embodiment, the method includes parameterizing, training, or otherwise calibrating a model, e.g., the model 128 (see FIG. 1) (act 200), customizing the model for a patient (e.g., the patient 112) (act 204), generating or predicting an estimate or forecast of or a prediction for the model state (act 208), converting the forecasted, estimated, or predicted model state into a disease progression probability or a Probability of Progression) (act 212), determining or calculating the future test timing or time until next test based on the disease progression probability and a disease progression threshold (act 216), and obtaining or receiving further, new, or additional test measurement data for the patient (e.g., the patient 112) (act 220). In other embodiments, the operation or method may include additional, fewer, or different acts or steps. For example, the calibrating act (act 200) and/or the obtaining act (act 220) need not be performed. The calibrating act (act 200) may, in some embodiments, only be performed once (e.g., initially, before using the model). In other embodiments, some of the acts described herein may be performed more than once. For example, the customizing, generating, converting, and determining may be performed for each patient, for different medical tests (e.g., medical tests 160), or a combination thereof. As another example, after the obtaining act (220), the generating, converting, and determining acts (acts 208, 212, and 216) may be performed again for the patient (e.g., the patient 112).

In act 200, the model is parameterized, trained, or otherwise calibrated. The model 128 is, at least initially, calibrated with respect to one disease or condition. The model is trained or otherwise calibrated with or using data of the progression of the disease or condition for a patient population set. The patient population set includes a plurality of patients (e.g., patients 112) having the same or different disease(s) or condition(s). The patient population set may or may not include the patient 112. The data for the patient population set includes quantifiable measurements about or indicative of the state of the disease for each patient in the patient population set. The quantifiable measurements may be obtained in any number of ways, such as, for example, via Clinical studies.

Any number of parameters of the model may be calibrated. For example, the model may include the following parameters: the matrices T (linear system dynamics, such as the progressive nature of the disease), Q (process noise co-variance), Z (the observation matrix that allows some or all of the states to be measured in a possibly altered form), H (measurement noise co-variance), \hat{α}₀ (initial state mean), and \hat{Σ}₀ (initial state covariance). The parameters may be time-variant or time-invariant. The model, and the parameters thereof, may be calibrated or trained in any number of ways. In one embodiment, the model is calibrated using or via an expectation maximization (EM) processor or algorithm. The processor, may, for example, be implemented in Matlab. In other embodiments, the model may be calibrated using or via logistic regression, multivariate regression, or other algorithms or functions. Once calibrated, the model includes a model or disease state representative of the disease progression for the patient population. In other embodiments, the model may be parameterized with respect to additional or different diseases or conditions and/or additional or different patient population sets. As noted above, in some embodiments, the model need not be calibrated or the model may only be calibrated once (e.g., initially).

In act 204, the model is customized for the patient (e.g., the patient 112). The model is customized based on or as a function of test and/or measurement history data (e.g., quantifiable measurements from previously given medical tests) and/or other data for the patient. The test history data for the patient may include the initial test data for the patient (initial disease progression information or data at one or more points in time), test data for the patient obtained after the initial customization of the model, or a combination thereof. Test data for the patient may be dynamically fed into the model, such that the model may be continuously customized based on or as a function of additional or new test data for the patient. Once the model is customized, the model state of the model is representative of the disease progression for the specific patient.

In act 208, a future model state or an estimate or forecast of a prediction for the model state may be generated or predicted. The future model state is predicted or generated by the customized model (e.g., the model 104). As noted above, in some embodiments, the model, such as the model 128, may include a linear Gaussian system that includes a Kalman filter. In these embodiments, the predicted model state is generated by the Kalman filter. The future, forecasted, or predicted model state may be generated based on a current representation of the model state of the model, current measurement data for a test, such as one of the medical tests 160, administered or given to the patient, process noise (e.g., biological noise) arising during the progression of the disease, or combinations thereof. Additionally or alternatively, in other embodiments, the forecasted model state may be generated based on additional and/or different factors and/or data.

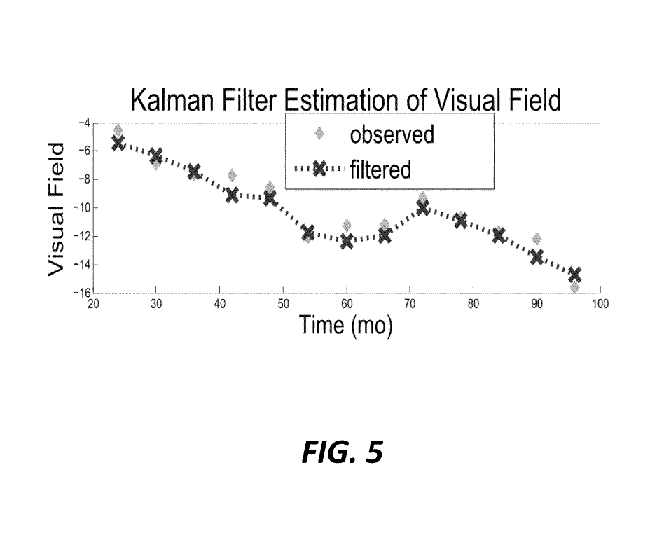

FIG. 5 depicts an embodiment in which predicting or generating the future model state (act 208) includes obtaining the last or more recent distribution estimates (e.g., co-variance, mean) (act 300), estimating or calculating the distribution of the next or future state (act 304), obtaining or receiving new measurement observation or data (act 308), updating the model to include or incorporate the new measurement observation (act 312), and determining an updated or optimal model state based on the updating and the estimated distribution of the next or future state (act 316). In other embodiments, predicting or generating the future model state may include additional, fewer, or different acts. For example, the obtaining, updating, and determining acts (acts 308, 312, 316, respectively) may not be performed. The updating and determining acts (acts 312, 316, respectively) may not be performed when, for example, new measurement observation(s) or data is not obtained or received (act 308). In some embodiments, the obtaining, updating, and determining acts (acts 308, 312, 316, respectively) may be performed more than once.

In act 300, the most recent distribution estimate (e.g., the mean and covariance) with information up to time t, \hat{α}_{t|t} and \hat{Σ}_{t|t}, may be obtained or received. Using the most recent distribution estimate, the mean and co-variance parameters that completely characterize the state of the linear Gaussian system based on noisy observations may be estimated or predicted (act 304). This may, in some embodiments, be performed by the Kalman filter. Estimation of the mean and co-variance parameters may be performed or accomplished using the linear system dynamics model from Eq. (2), noted above, to predict the future state as

\hat{α} [symbol] =T [symbol] (4)

\hat{Σ} [symbol] =T\hat{Σ} [symbol] T [symbol] +Q. (5)

where \hat{α} [symbol] and \hat{Σ} [symbol] are the predicted mean and covariance at time t+1 given observations up to time t. The prime symbol, ′, represents the matrix transpose. In other embodiments, the forecasted model state may be generated using other equations, matrices, or models. Any number of model states may be estimated, forecasted, or predicted.

Predicting or generating the estimated model state (act 208) may, in some embodiments, be recursively implemented or performed. In these embodiments, predicting or generating the estimated model state (act 208) may include obtaining or receiving the new measurement observation(s) or data (act 308) and updating the customized model based on or as a function of further measurement data for the test for the patient (act 312). In other words, when further or new measurement data for the test for the patient is available and received or obtained, the model may be updated based on or to include this further measurement data. The model may be updated to minimize or by minimizing error between the predicted future model state and the new measurement data, which, as noted above, includes test measurement noise. The model may be updated by, for example, minimizing a function of the co-variance of the estimate with the mean error being unbiased (i.e., the mean error is zero) between the forecast of the model state and test measurement data for the patient. In some embodiments, the Kalman filter may update the model. In other embodiments, the model may be updated using other filters or updating methods (e.g., using Bayesian updating).

Predicting or generating the estimated model state (act 208) may further include determining or calculating the optimal or updated model state prediction based on the update or correction and the previously predicted future model state (act 316). However, during each implementation or performance of the predicting or generating (of the estimated model state) in which further measurement data is not available and/or received (act 308 is not performed), the model is not updated (act 312 is not performed). The new observations may be used to optimally update or correct the predicted model state given by the model so as to minimize the mean squared error of the estimate: E[|αₜ−\dot{α}ₜ|²]. When a new observation is obtained, the error between the predicted model state and the observation is used to calculate the optimal new or updated state estimate. First, the measurement residual, yₜ₊₁, and the predicted covariance around the measurement, Sₜ₊₁, are calculated as

ŷₜ₊₁=x [symbol] −Z\hat{α} [symbol] (6)

X [symbol] =X\hat{Σ} [symbol] Z [symbol] +H. (7)

The optimal Kalman gain, Kt+1, is the solution to an optimization that minimizes the trace of the estimated covariance matrix (and thereby minimizes the mean squared error of the estimate). The optimal Kalman gain is given by

K [symbol] =\hat{Σ} [symbol] Z [symbol] −S [symbol] (8)

The optimal Kalman gain from Eq. (8) is used to calculate the optimal new state estimate (i.e., the new or updated predicted model state), \hat{α} [symbol] and \hat{Σ} [symbol] , for the Gaussian state random variable as

\hat{α} [symbol] =\hat{α} [symbol] +K [symbol] (9)

\hat{Σ} [symbol] =(I−K [symbol] Z)\hat{Σ} [symbol] (10)

where I is the identity matrix. Eqs. (9) and (10) are the equations that define the recursive Kalman estimator and will be referenced below.

Since the disclosed embodiments aim to consider a dynamic testing schedule based on or depending on the condition of each specific patient, the optimal time interval between tests may vary from one measurement to the next depending on the stability of a given patient's disease progression at prior time points. Therefore, any number of future model states may be predicted before the model is updated. By eliminating the update step for periods in which no observation is performed, the linear transition equation may be recursively applied to obtain the l-step prediction equation (i.e. predicting periods into the future) as

$$\begin{matrix} \text{?} = \text{?} \text{?} & ( 11 ) \\ \text{?} = \text{?} \text{?} {( \text{?} )}^{′} + \text{?} \text{?} Q \text{?} , \\ \text{?} \text{indicates text missing or illegible when filed} & ( 12 )\end{matrix}$$

where α [symbol] is the Gaussian state variable at time l, given that observations are available through time t (i.e., the observation history). The first element of the sum represents the multi-period linear state transition and the second element of the sum represents the multi-period process noise accumulation.

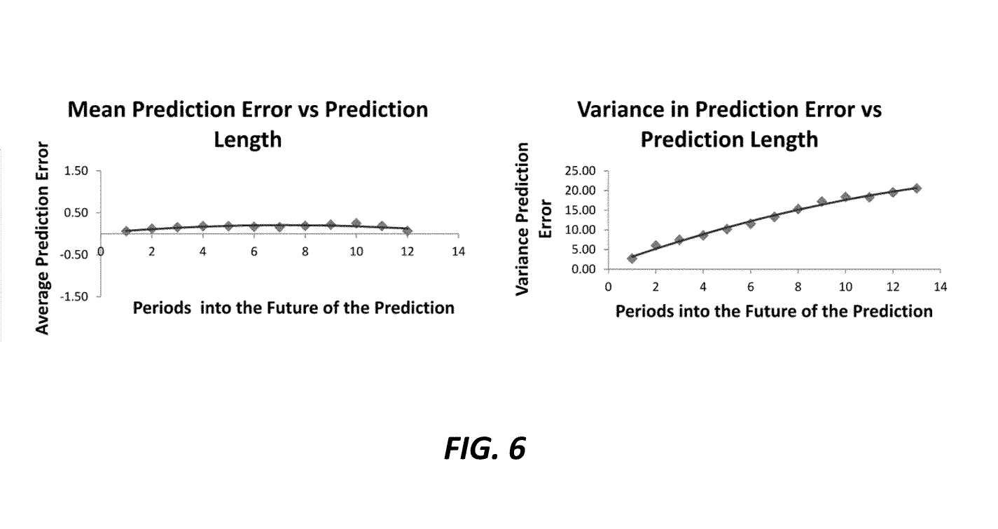

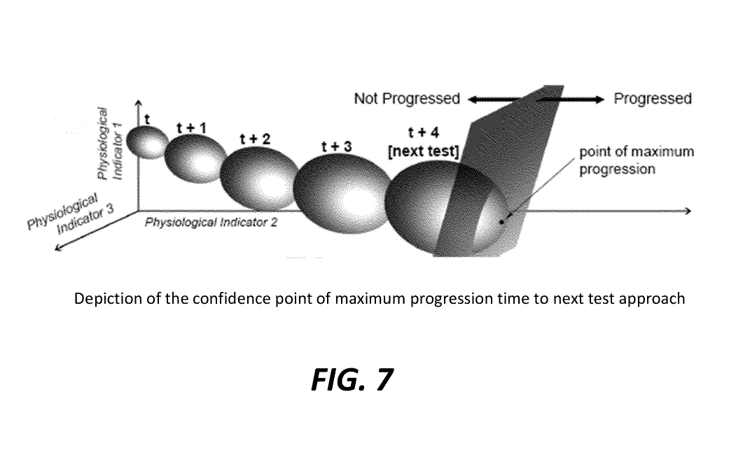

In one embodiment, the above-described acts of the method or operation, e.g., the acts 200, 204, and 208, were implemented with data from a clinical trial, the Collaborative Initial Glaucoma Treatment Study (CIGTS). First, the model (e.g., the model 128) was calibrated using data obtained or gathered from a subset of a patient population set with glaucoma and that participated in the CIGTS. The calibrated model was then tested on patients who were not part of that subset but were enrolled in the CIGTS trial. For each patient in the test set, the future model state of his/her glaucoma was predicted from that patient's first two years in the trial (the first two years were used as a “warm up”) through the end of the patient's trial. Since most forms of glaucoma tend to progress very slowly over the course of many years, a two year warm up was deemed reasonable for this disease, but the transient period may be modified to fit the specific disease in question. Although patients in the CIGTS had variable follow-up, the predictions generated by the model were, at least for most patients, tested for up to six years into the future. The prediction error was then measured by comparing the predicted or estimated mean state with the actual observations. FIG. 6, which illustrates the predicted or estimated state of VF (which is an indicator of glaucoma progression) and the actual VF as a function of time, and FIG. 7 and Table 1, which depict mean prediction error and the variance in prediction error as a function of length or time into the future, show that the linear systems model for state prediction has very little bias.

| | Months Predicted into the Future | | | | | | | | | |
|---|---|---|---|---|---|---|---|---|---|---|
| | 6 mo | 12 mo | 18 mo | . . . | 42 mo | 48 mo | 54 mo | 60 mo | 66 mo | 72 mo |
| Mean | 0.06 | 0.12 | 0.16 | . . . | 0.16 | 0.19 | 0.22 | 0.25 | 0.19 | 0.07 |
| Var | 2.72 | 0.05 | 7.47 | . . . | 13.28 | 15.29 | 17.19 | 18.38 | 18.28 | 19.53 |

In act 212, the forecasted, estimated, or predicted model state is converted into a disease progression probability or a Probability of Progression). By converting the predicted model state into the disease progression probability, the disclosed embodiments may identify, and help a clinician (e.g., the clinician) 108 utilize, the multi-dimensional space of information over the test history of the patient 112. The clinician may use this multi-dimensional space of information to make decisions as to how best to treat their patients (e.g., the patient 112). In some embodiments, the conversion may be performed by or using a logistic regression function, such as the Probability of Progression (ProP) function. In other embodiments, the conversion may be performed by or using any number of other functions, algorithms, models, or the like. For example, the conversion may be performed by or using parametric and/or non-parametric models. In the embodiments in which a plurality of model state forecasts are generated, the plurality of model state forecasts may be converted into corresponding representations of disease progression probability (or corresponding Probabilities of Progression).

The conversion may be performed by a logistic regression function, such as the Probability of Progression (ProP) function, which aims to identify and properly utilize the multi-dimensional space of information over the test history of the patient 112. By converting the predicted model state into the Probability of Progression, the disclosed embodiments aim to help the clinician 108 interpret the multi-dimensional data and make decisions as to how best to treat their patients (e.g., the patient 112).

The logistic regression function described herein, ƒ(x) (see Eq. (13)), is defined or formulated to link, tie, or connect a plurality of factors or indicators to the probability of progression, while at the same time accounting for the measurement and process noise components of these factors. The logistic regression function, ƒ(x), may be a mapping function that maps the state space of the plurality of indicators or factors (e.g., the physiological factors) to a measure of disease progression the probability of progression.

$$f ( x ) = \frac{1}{1 + \text{?}} \\ \text{?} \text{indicates text missing or illegible when filed} \qquad ( 13 )$$

The logistic regression function may include any number of different physiological factors or indicators, such as, for example, abnormalities of the VF and the IOP level (when the disease is glaucoma). The logistic regression function may, alternatively or additionally, include risk factors such as, for example, age, race, gender, etc., depending on the specific disease. In Eq. (14) below, z(x) is a linear function of the factors or indicators. The risk factors factors are captured by the progression vector, a, in Eq. (14), which is so-called because it represents the n-dimensional direction of steepest ascent toward progression. In some embodiments, the logistic regression function is defined to include the factors or indicators at or for two points in time: (1) the current moment (immediately after a new measurement is taken) and (2) a future moment at which the next measurement should be taken.

z(x)=b+aX (14)

The ProP function may link any number of factors, and, thus, the patient disease state, with the probability of progression, and, thus, disease progression. For example, the ProP function may link patient disease state to disease progression by combining the widely-accepted Hodapp-Anderson-Parrish (HAP) criteria to quantify that progression has occurred with a loss of 3 dB of mean deviation (the mean deviation is a summary measure of VF loss which is referred to as the “VF score” herein with respect to the patient's baseline.

In act 216, the future test timing (or time until next test) may be determined or calculated based on the disease progression probability and a disease progression threshold. The idea here is that a test is only performed when the clinician is no longer sufficiently confident that the patient has not progressed (e.g., that the patient's disease has not progressed). In these embodiments, to determine the Time until or to Next Test (TNT), the trajectory of the patient disease state is forecasted into the future until the point at which the disease progression probability, or, more particularly, the ProP function, hits the progression threshold (e.g., the point of maximum progression). The threshold indicates that there is a sufficient likelihood of progression, such that a test (the Next Test) should be performed. The optimal interval of time in between tests is therefore determined by the length of time it takes for the disease state forecast to reach the progression threshold. In some embodiments, the TNT may be determined by forecasting the trajectory of the patient disease state into the future until the disease progression probability, or, more particularly, the ProP function, exceeds the progression threshold by a specific amount and/or for a specific period of time. The optimal interval of time between tests in this embodiment is therefore determined by the length of time it takes for the disease state forecast to exceed the progression threshold by the specified amount and/or for the specified amount of time. In other embodiments, two or more future test timings (or two or more times until next test) may be determined or calculated based on the disease progression probability and a plurality of disease progression thresholds. In these other embodiments, the trajectory of the patient disease state is forecasted into the future until the point at which the disease progression probability hits two or more of the plurality of progression thresholds. In turn, two or more times may be determined that correspond to the time at which the test should be administered or given for the respective disease progression threshold. By including more than one progression threshold, the clinician may be presented with two or more options, or several times at which tests may be administered (depending on the respective disease progression threshold).

One challenge is that the predicted future state is not a deterministic point in n-dimensional space, but is, rather, an n-dimensional Gaussian random variable. Determining the future testing timing may include estimating a stochastic maximum possible disease progression probability (e.g., the Point of Maximum Progression (POMP) function). The POMP function may be estimated by maximizing the logistic regression function (e.g., the ProP function) over a Gaussian distribution or density of the model state forecast in accordance with a predetermined confidence level. The result is the point of maximum progression, or “worst” point, within a confidence region (determined by the confidence level) around the mean state vector. The confidence region around the mean state vector is meant to be a conservative estimate of the probability of disease progression for the patient.

The Gaussian prediction region in the disclosed embodiments is an n-dimensional ellipsoid, where n is the dimension of the state space. The 100ρ% prediction region for the Gaussian random variable may be defined with mean \hat{α}_{t+l|t} and covariance \hat{Σ}_{t+l|t} for l periods in the future as

[symbol]

_{ρ}(\hat{α}_{t+l|t},\hat{Σ}_{t+l|t})={x:(x−\hat{α}_{t+l|t})′\hat{Σ}_{t+l|t}⁻¹(x−\hat{α}_{t+l|t})≦x²(1−ρ,n)}, (15)

where \hat{α}ₜ and \hat{Σ}ₜ represent our current estimate of the mean and covariance of the disease state at time t and χ₂(1−ρ,n) is the 1−ρ quantile of the chi-square distribution with n degrees of freedom.

Accordingly, maximizing the logistic regression function ƒ(x) (e.g., the ProP function) over a Gaussian distribution or density of the model state forecast may include maximizing the logistic regression function ƒ(x) over the prediction region [symbol] _{ρ}(\hat{α}_{t+l|t},\hat{Σ}_{t+l|t}). Given the current state estimate, \hat{α}ₜ and \hat{Σ}ₜ, the stochastic Point of Maximum Progression (POMP) function, h_{ρ}, with respect to the ProP function, ƒ(x), for the l-step state forecast is given by:

$${h}_{ρ} ( {\hat{α}}_{t \vert t} , {\hat{Σ}}_{t \vert t} , l ) = {max}_{x ∈ {D}_{ρ} ( {\hat{α}}_{t + l \vert t} , {\hat{Σ}}_{t + l \vert t} )} f ( x ) , \qquad ( 16 )$$

where \hat{α}_{t+l|t},\hat{Σ}_{t+l|t} are obtained from \hat{α}_{t|t},\hat{Σ}_{t|t} through Eqs. (11) and (12).

In the above-described embodiment, the Gaussian prediction region, [symbol] _{ρ}(\hat{α}_{t+l|t},\hat{Σ}_{t+l|t}), defined by Eq. (15) and included in Eq. (16) is convex. Meanwhile, maximizing the Prop function, ƒ(x), is equivalent to maximizing z(x) (see Eq. (13)), which, as noted above, is a linear function of x. In turn, finding the point of maximum progression is a convex optimization problem. In this embodiment, this convex optimization problem may be solved utilizing the Karush-Kuhn-Tucker (KKT) conditions. In other embodiments, the convex optimization problem may be solved in a different way.

The POMP function may be given by a closed form solution that solves the optimization problem. In one embodiment, given the l-step prediction region [symbol] _{ρ}(\hat{α}_{t+l|t},\hat{Σ}_{t+l|t}), defined by Eq. 15 with ρε(0,1), and progression vector a, the closed form solution for the maximum value of the ProP function, h_{ρ}, is given by Eq. (17):

$${h}_{ρ} ( {\hat{α}}_{t \vert t} , {\hat{Σ}}_{t \vert t} , l ) = {max}_{x ∈ {D}_{ρ} ( {\hat{α}}_{t + l \vert t} , {\hat{Σ}}_{t + l \vert t} )} {a}^{′} x = {a}^{′} {\hat{α}}_{t \vert l \vert t} + \sqrt{{χ}^{2} ( 1 - ρ , n ) {a}^{′} {\hat{Σ}}_{l + l \vert t} a} \qquad ( 17 )$$

Accordingly, the closed form for the associated disease state, \tilde{h}ₚ, is given by Eq. (18):

$${\tilde{h}}_{ρ} ( {\hat{α}}_{t \vert t} , {\hat{Σ}}_{t \vert t} , l ) = {argmax}_{x ∈ {D}_{ρ} ( {\hat{α}}_{t + l \vert t} , {\hat{Σ}}_{t + l \vert t} )} {a}^{′} x = {\hat{α}}_{t + l \vert t} + ( \sqrt{\frac{{χ}^{2} ( 1 - ρ , n )}{{a}^{′} {\hat{\sum }}_{t + l \vert t} a}} ) \cdot {\hat{Σ}}_{t + l \vert t} a . \qquad ( 18 )$$

In other embodiments, other closed form solutions may be developed and used.

From the closed form solution, or POMP function, the time to next test (TNT) function may be determined. In this embodiment, the TNT function, F_{ρ,τ}(\hat{α}_{l|t},\hat{Σ}_{t|l}), is given by Eq. (19):

$${F}_{ρ , τ} ( {\hat{α}}_{t \vert t} , {\hat{Σ}}_{t \vert t} ) = {min}_{l ∈ ℤ +} l s . t . {h}_{ρ} ( {\hat{α}}_{t \vert t} , {\hat{Σ}}_{t \vert t} , l ) \geq τ . \qquad ( 19 )$$

where F_{ρ,τ}: [symbol] ⁿ×( [symbol] ⁿ× [symbol] ⁿ)→ [symbol] , maps the current state to the time interval between the current observation and the next observation, and τ is the given or selected progression threshold. In other embodiments, different TNT functions may be determined and utilized.

In the above-described embodiment, the POMP function, h_{ρ}, monotonically increases in l. As such, the TNT function may be solved with or using iterative search techniques. As an example, a simple binary search that divides the search space in half at each iteration can solve this function for a problem with n possible testing epochs, in the worst case on order of O(log(n)), because the terms are monotonically increasing in l. Even in the worst case, this is faster than a traditional binary search because of the special structure. Thus even when the search space is large, the algorithm finds the solution quickly. For example, when monitoring a disease on intervals of 1 second over the course of the year, the search space is thus 31,449,600 seconds/year. The binary search finds the optimal monitoring time in at worst 25 function evaluations plus comparisons, which a computer could solve instantaneously. Once solved, the results of the TNT algorithm (the time until next test) may be sent or transmitted from the model to the clinician. The clinician may utilize the determined time until next test to treat or care for the patient.

The TNT algorithm has several structural aspects that provide insight about the monitoring and testing of chronic disease patients with the disclosed embodiments. First, the further into the future the disease state is projected, the more uncertainty there is as to whether the patient has progressed or not, and, thus, the more likely it is that the model will determine that the next test should be given or administered. Secondly, the more patient observations the model has, the smaller the estimated covariance is in the direction of progression, a (i.e. the direction of the progression vector a from Eq. 14). Moreover, when there is little information about the patient, the more frequently the model determines that additional tests are to be administered to the patient. Finally, the worse off (i.e. closer to progression) the patient is, the more frequently the model determines that additional tests are to be administered or given to the patient.

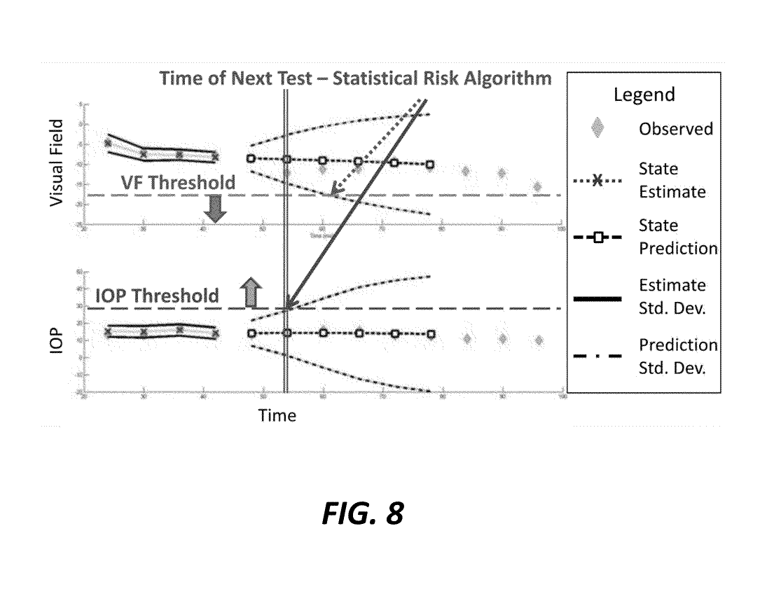

FIG. 8 is a graphical plot that depicts an example of how the time to next test is determined with respect to a three-dimensional state space. The plot includes an ellipse for each period t, t+1, t+2 that represents the 100ρ% confidence region around the model state estimate for that period. The ellipse at period t (the current period) represents the 100ρ% confidence region around the model state estimate for that period. The periods t+1, t+2, . . . , represent future periods as the disease model state for the patient is projected further into the future. As the disease model state for the patient is projected further into the future, the center of the confidence region (i.e., the forecasted mean state) moves in accordance with the disease dynamics (i.e., transition matrix T). In addition, the confidence region expands as the co-variance around the forecasted mean state grows the further into the future the model state is projected. The time of the next test occurs at the first period in which the forecasted confidence region intersects or exceeds the progression threshold (and n-dimensional hyper plane), which is illustrated by the plane in FIG. 8. The time of the next test thus occurs at period t+4 in FIG. 8.

FIG. 9 presents a pair of graphical plots that depict an exemplary time to next test (TNT) determination, using the TNT function, for a VF test (upper graph) and an IOP test (lower graph) when the patient has glaucoma. The upper graph included in FIG. 9 depicts the model disease state for the patient, the predicted model disease state for the patient, the disease progression probability for the patient, and the predetermined progression threshold (for VF). The TNT function, using this information, determines the TNT for the VF test. The TNT occurs or exists where the disease progression probability intersects the VF progression threshold, which, as shown in the upper graph, occurs just to the right of the vertical double line (see the arrow). The lower graph included in FIG. 9 depicts the model disease state for the patient, the predicted model disease state for the patient, the disease progression probability for the patient, and the progression threshold for IOP. The TNT function, using this information, determines the TNT for the IOP test. The TNT occurs or exists where the disease progression probability intersects the IOP progression threshold, which, as shown in the lower graph, occurs approximately on or on the vertical double line (see the arrow). The clinician should, in turn, administer or give the VF and IOP tests to the patient at the determined TNTs, respectively.

In the disclosed embodiments, the parameters T and ρ utilized when determining the time until next test (act 216) may be adjusted or customized.) The parameter T controls or determines the progression threshold. If, for a given model state, the ProP function produces a value greater than 1/(1+e−τ), the patient is considered to have progressed. Hence, the smaller the τ, the more frequently the forecasted confidence region will intersect the progression threshold, and, thus, the more frequently model will recommend tests. Conversely, the larger the τ, the less frequently the model will recommend tests.

The parameter ρ controls or determines the size of the confidence region around the predicted mean disease state (the radius of the ellipse in FIG. 8). In other words, the parameter ρ controls or determines the confidence level that there has been no progression. The larger the ρ, the more frequently the model will recommend tests. Conversely, the smaller the ρ, the less frequently the model will recommend tests.

The parameters τ and/or ρ may be set or chosen based on or to fit or accommodate patient-specific needs (e.g., financial resources, risk tolerance, overall health) and/or a patient-specific treatment strategy. The parameters τ and/or ρ may be set to produce a more aggressive treatment strategy for the patient, or a less aggressive treatment strategy for the patient. The parameter ρ may, for example, be set to 90% when a highly aggressive treatment strategy is desired or needed for the patient, but may be set to 60% when a less aggressive treatment strategy is desired or needed for the patient. For example, a less aggressive treatment strategy may be appropriate for an older glaucoma patient who has other illnesses due to the low likelihood the patient will go blind in his/her remaining years and because the risks of additional treatment may outweigh the potential benefits. This will lead to longer intervals between tests and thus less frequent testing. Alternatively, a more aggressive strategy (set by, for example, increasing ρ) may be appropriate for a young, healthy glaucoma patient so that testing is more frequent to avoid missing detection of irreversible vision loss.

The parameters τ and/or ρ may be chosen or set by or via user input (e.g., by or via the clinician). In some embodiments, the parameters τ and/or ρ are directly and individually selected by the user (e.g., the clinician). In other embodiments, the parameters τ and/or ρ may be chosen or set based on an aggressiveness scale. The aggressiveness scale may include any number of different levels, such as, for example high and low; high, medium, and low; high, above average, average, below average, and low; etc. Each level may correspond to a value for τ, ρ, or both τ and ρ. The clinician may select a level of aggressiveness, which, in turn, corresponds to a value for τ, ρ, or both τ and ρ. For example, when the clinician selects a “high” level of aggressiveness, the corresponding parameter(s) value(s) will be chosen or selected. The corresponding parameter(s) value(s) corresponding to this level of aggressiveness will generally recommend more frequent tests.

The parameters τ and/or ρ may be adjusted, updated, or modified by or via user input (e.g., by or via the clinician) in response to a change in patient-specific needs and/or a change in the patient-specific treatment strategy. For example, when the financial situation of the patient changes, the parameter τ may be adjusted or modified to reflect the patient's ability or willingness to be tested more or less frequently. The parameters τ and/or ρ may be directly updated by the user (e.g., the clinician) or based on or using the aggressiveness scale. In the latter situation, the aggressiveness level may be changed (for example, from high to above average), which will, in turn, change the value of the parameters τ and/or ρ. The parameters τ and/or ρ may be changed at any time and/or may be changed any number of times.

In some embodiments, new, further, or additional measurement data for the patient may be obtained or received (act 220). The test measurement data may be received at non-fixed (i.e., variable) time intervals. Once further test measurement data has been received or obtained, the acts of generating the forecast of the model state (act 208), converting the model state forecast into a disease progression probability (act 212), determining the future test timing (i.e., time until next test) (act 216), or combinations thereof, may be performed once again. Further test measurement data may be received any number of times.

Unlike the current practice of utilizing testing intervals that are fixed, the disclosed embodiments utilize variable testing intervals. The disclosed embodiments may determine or calculate the length of one or more of these variable testing intervals using indicators or factors, such as physiological factors, of disease progression based on the patient's test history data.

The disclosed embodiments are directed to predicting future disease progression test results with a model of disease dynamics based on prior test results (e.g., VF, IOP, etc.). This approach need not include or generate an overall or global measure of disease severity. As described above, the disease progression data generated by the disclosed embodiments may then be used to determine the timing of a next test.

The disclosed embodiments may determine and apply the rate of change of various parameters and test measurements as well as other derivatives (e.g., acceleration, jerk) to generate the disease progression model. The generated models may be non-linear models of the disease dynamics and, rather than focus on an instantaneous measure of disease state or progression at the time of the most recent test, the disclosed embodiments are instead directed to (1) forecasting future values of measures related to the disease, such as, for example, VF and IOP (when the disease is glaucoma), and (2) computing a recommended time-to-next-test (TNT). In this way, the disclosed embodiments may determine the likelihood of disease stage or state changes in the future that warrant a physician's visit or other action. The probabilities of progression at future points in time allow the clinician to generate a customized patient schedule.

The network(s) or other communication connections described above may include wired networks, wireless networks, or combinations thereof. The wireless network may be a cellular telephone network, an 802.11, 802.16, 802.20, or WiMax network. Further, the networks may be a public network, such as the Internet, a private network, such as an intranet, or combinations thereof, and may utilize a variety of networking protocols now available or later developed including, but not limited to TCP/IP based networking protocols.

The methods disclosed herein may be implemented via computer-readable instructions stored on a computer-readable medium. The computer-readable medium may be a single medium, or the computer-readable medium may be a single medium or multiple media, such as a centralized or distributed database, and/or associated caches and servers that store one or more sets of instructions. The term “computer-readable medium” may also include any tangible medium that may be capable of storing, encoding or carrying a set of instructions for execution by a processor or that may cause a computer system to perform any one or more of the methods or operations disclosed herein.

The computer-readable medium may include a solid-state memory such as a memory card or other package that houses one or more non-volatile read-only memories. The computer-readable medium also may be a random access memory or other volatile re-writable memory. Additionally, the computer-readable medium may include a magneto-optical or optical medium, such as a disk or tapes or other storage device. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or additionally, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the disclosed system may encompass software, firmware, and hardware implementations.

The methods described herein may be implemented by software programs executable by a computer system. Further, implementations may include distributed processing, component/object distributed processing, and parallel processing. Alternatively or additionally, virtual computer system processing may be constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

While the invention has been described above by reference to various embodiments, it should be understood that many advantages and modifications can be made without departing from the scope of the invention. It is therefore intended that the foregoing detailed description be regarded as illustrative rather than limiting, and that it be understood that it is the following claims, including all equivalents, that are intended to define the spirit and the scope of this invention.

What is claimed is:

1. A computer-implemented method of modeling and forecasting progression of a disease for a patient, the method comprising:
customizing, by a processor, the multivariate state space model for the patient based on test history data for the patient, the multivariate state space model comprising a model state representative of the progression of the disease for the patient;
generating, by the processor using the customized multivariate state space model, a forecast of the model state based on a current representation of the model state and current measurement data for a test directed to observing progression of the disease; and
converting, by the processor, the model state forecast into a disease progression probability.

2. The computer-implemented method of claim 1, wherein the multivariate state space model comprises a linear Gaussian system, and wherein the model state specifies a current configuration of the linear Gaussian system.

3. The computer-implemented method of claim 2, wherein the linear Gaussian system comprises a Kalman filter.

4. The computer-implemented method of claim 1, wherein the current representation of the model state and the model state forecast are specified via respective Gaussian distributions.

5. The computer-implemented method of claim 1, wherein generating the model state forecast comprises updating the customized multivariate state space model based on further measurement data for the test.

6. The computer-implemented method of claim 1, wherein generating the model state forecast further comprises:
predicting a future model state based on a linear state transition matrix of the customized multivariate state space model and a representation of biological process noise arising during the progression of the disease; and
updating the multivariate state space model by minimizing error between the predicted future model state and new test data for the patient, the new test data comprising a representation of test measurement noise.

7. The computer-implemented method of claim 6, wherein predicting the estimate of the future model state is recursively implemented, and updating the multivariate state space model is not performed during each implementation of the forecast generating act in which the new test data is not available.

8. The computer-implemented method of claim 1, wherein converting the model state forecast comprises mapping the model state forecast to the disease progression probability via a logistic regression function.

9. The computer-implemented method of claim 1, further comprising determining, by the processor, a future timing of the test for the patient based on the disease progression probability and a progression threshold.

10. The computer-implemented method of claim 9, wherein determining the future test timing comprises estimating a maximum possible disease progression probability by maximizing the logistic regression function over a Gaussian distribution of the model state forecast in accordance with a confidence level.

11. The computer-implemented method of claim 9, wherein the progression threshold is adjustable, via user input, based on individual needs of the patient.

12. The computer-implemented method of claim 1, further comprising receiving the current measurement data at non-fixed intervals.

13. The computer-implemented method of claim 1, wherein the disease is glaucoma, and wherein the model state comprises representations of second and third derivatives with respect to time of visual field data, intraocular pressure data, or a combination of the visual field data and the intraocular pressure data, for the patient.

14. The computer-implemented method of claim 1, further comprising calibrating the multivariate state space model based on training data indicative of the progression of the disease for a patient population state.

15. A system for determining future timing of a test for a patient, the test being directed to observing progression of a disease, the system comprising a memory and a processor in communication with the memory, the system further comprising:
a first module stored on the memory and executable by the processor to cause the processor to customize the multivariate state space model for the patient based on test history data for the patient, the multivariate state space model comprising a model state representative of the disease progression for the patient;
a second module stored on the memory and executable by the processor to cause the processor to generate, using the customized multivariate state space model, a forecast of the model state based on a current representation of the model state and current measurement data for the test;
a third module stored on the memory and executable by the processor to cause the processor to convert the model state forecast into a disease progression probability; and
a fourth module stored on the memory and executable by the processor to cause the processor to determine the future test timing based on the disease progression probability and a progression threshold.

16. The system of claim 15, wherein the multivariate state space model comprises a linear Gaussian system that includes a Kalman filter, and wherein the model state specifies a current configuration of the linear Gaussian system.

17. The system of claim 15, wherein the model state is specified via a Gaussian distribution.

18. The system of claim 15, wherein the second module is executable by the processor to cause the processor to update the multivariate state space model by minimizing error between the forecast of the model state and test measurement data for the patient.

19. The system of claim 18, wherein the test measurement data is received at non-fixed intervals.

20. The system of claim 15, wherein the disease is glaucoma, and wherein the model state comprises representations of second and third derivatives with respect to time of visual field data and intraocular pressure data for the patient.

21. The system of claim 15, wherein the progression threshold is determined based on a multi-zone aggressiveness scale.

22. A computer program product stored on a tangible computer-readable medium and comprising computer-readable instructions, the computer-readable instructions being executable by a processor to monitor progression of a disease for a patient, the computer-readable instructions comprising:
a first instruction set configured to calibrate a multivariate state space model of the disease progression with training data of the progression of the disease for a patient population set, the multivariate state space model comprising a linear Gaussian system and a model state representative of the disease progression, the model state specifying a current configuration of the linear Gaussian system;
a second instruction set configured to customize the multivariate state space model for the patient based on test history data for the patient;
a third instruction set configured to generate, using the customized multivariate state space model, a prediction of a future model state based on the model state and a representation of biological process noise arising during the progression of the disease; and
a fourth instruction set configured to update the multivariate state space model by minimizing error between the prediction of the future model state and test measurement data for the patient;
wherein the fourth instruction set is further configured to incorporate a representation of test measurement noise into the test measurement data.

23. The computer-readable instructions of claim 22, wherein the third instruction set is configured to recursively generate the prediction of the future model state, and wherein the fourth instruction set is configured not to update the multivariate state space model during a recursive generation period in which the test measurement data is not available.

24. The computer-readable instructions of claim 22, wherein the fourth instruction is configured to update the multivariate state space model by minimizing a function of a co-variance of the prediction of the future model state with a mean error being un-biased between the prediction of the future model state and test measurement data for the patient.
